(19) United States
(12) Patent Application Publication
(10) Pub. No.: US 2015/0324851 A1
(43) Pub. Date: Nov. 12, 2015

(54) Location Based Marketing System and Method

(71) Applicant: Vibes Media LLC, Chicago, IL (US)

(72) Inventors: Alexander Gates Campbell, Chicago, IL (US); John Haro, Chicago, IL (US)

(21) Appl. No.: 14/708,992

(22) Filed: May 11, 2015

Related U.S. Application Data
(60) Provisional application No. 61/991,226, filed on May 9, 2014.
(60) Provisional application No. 61/991,234, filed on May 9, 2014.

(51) Int. Cl. G06Q 30/02; H04W 4/00; H04W 40/24

(52) U.S. Cl. CPC G06Q 30/0261; G06Q 30/0267; H04W 40/244; H04W 4/008

(57) ABSTRACT

A system and method for providing marketing and advertising information utilizes hyper-location to determine what types of or the content of relevant information to display to one or more end users. In various embodiments, the hyper-location is determined from or transmitted by beacons that communicate with portable electronic devices carried by the end users. The hyper-location information may be specific geographic locations of the beacons and or end users or may be specific locations relative to other locations, such as a position within a store or venue.

### CROSS-REFERENCE TO RELATED APPLICATIONS

This application claims the benefit of U.S. Patent Application Ser. Nos. 61/991,226 and 61/991,234 each filed on May 9, 2014, the disclosures of which are hereby incorporated by reference in their entirety.

### TECHNICAL FIELD OF THE INVENTION

The present invention relates to marketing systems and methods. The present invention relates more particularly to marketing systems and methods utilizing hyper location based information and systems.

### BACKGROUND

Coupons, sales flyers and other marketing devices have transitioned from the traditional paper documents to digital items offering a broader range of customization. Together with loyalty cards, gift cards, event tickets, boarding passes and the like, these digital marketing devices are often referred to as “passes” (“pass” singular). These passes may be downloaded to, generated on, or otherwise accessed by a mobile computing device, such as a smartphone, tablet, PDS, portable media player of the like, as well as wearable technology such as smart watches, fitness monitors, smart glasses and the like. In typical use, a pass is stored in a digital wallet for later access and use.

The digital wallet and pass also allows direct marketing communication to the end user. For example, a pass may be designed such that the marketer who generated the pass can inform an end user that the pass is about to expire or has been updated. One example of a pass and electronic wallet system is the Passbook application available in the iOS operating system from Apple, Inc. Another example of a pass and electronic wallet system is the Google Wallet system available on the Android Operating System.

### SUMMARY OF THE INVENTION

With the advent and improvement of hyper location based information and services, passes are capable of increased functionality. Traditional passes could access general location information, such as GPS location on a smartphone. Using this general location information, the pass could be programmed to provide differing information based on the general location of the user. For example, if a pass is designed as a coupon for a discounted item that is redeemable at select locations of a franchise, the pass could be coded to only show the discounted price when the user is at or near a participating location. Alternatively, using the general location information and direct marketing communication features, a pass may be designed to alert the end user when the user is in the general vicinity of a store that will accept the pass. Likewise, different locations of a large franchise may run discounts or in-store specials on different items and a pass can be coded to show the relevant discounts or in-store specials based on the particular, general location of the user.

It would be desirable to determine the optimal information to present to the end user based on, for example, the location of the user, time of day, day of week, or other season, or input from the user.

It would be desirable to show the user content based on third party advertisers who want to target end users based on their exact location in a retail store.

It would be desirable to provide even more information to users and collect further information regarding users. It would further be desirable to provide more detailed marketing opportunities to marketers and end users based on the interests and habits of the end user.

### BRIEF DESCRIPTION OF THE FIGURES

FIG. 1 is a schematic representation of a marketing and advertising system according to an exemplary embodiment.

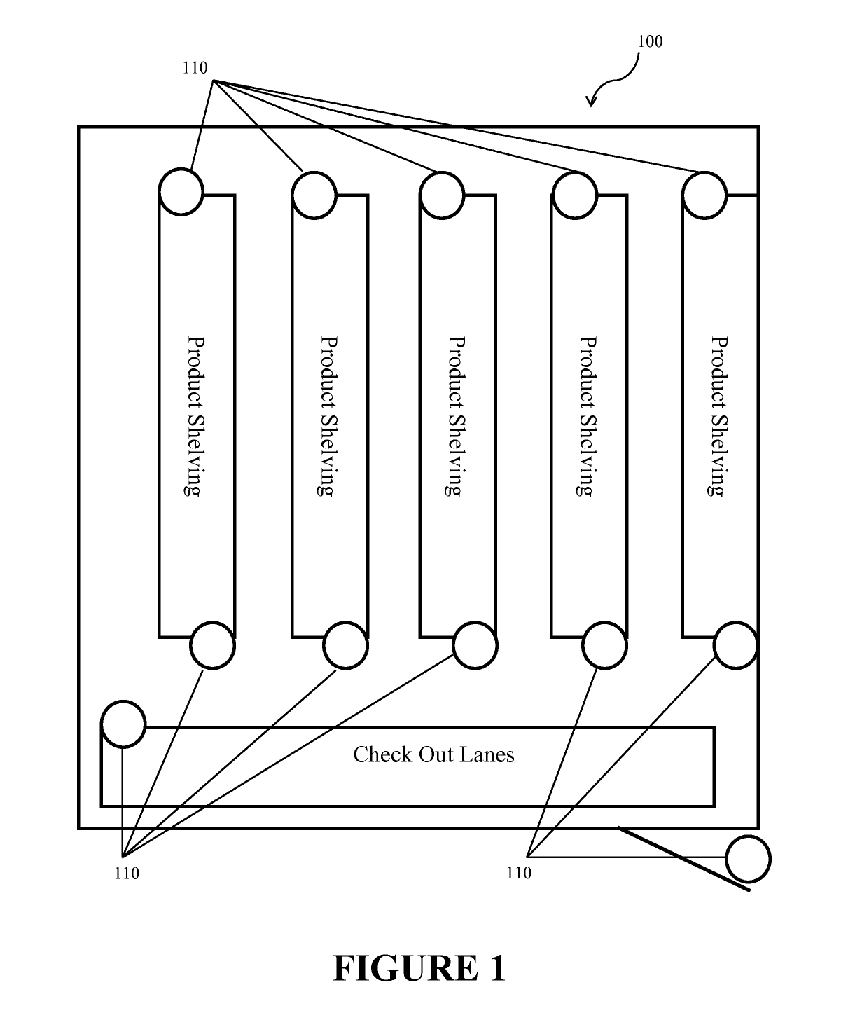

### DETAILED DESCRIPTION OF THE PREFERRED EMBODIMENTS

In an exemplary embodiment of a marketing system according to this invention, a target store 100 is equipped with sensors 110 that are usable to provide detailed location information about users in the store. It should be appreciated that in various exemplary embodiments, the target store may be a retail store, a kiosk, a storefront or any other suitable retail location that wishes to provide marketing information to perspective customers and other users.

In various exemplary embodiments, the sensors include Bluetooth LE equipped beacons or other suitable low-energy communication protocol sensors. Examples of suitable Bluetooth LE beacons include the iBeacons available from StickNFind Technologies of Uniondale, N.Y.; or the Mobile to Mortar™ iBeacon platform available from inMarket Media, LLC of Venice, Calif. In various exemplary embodiments, the sensor may include one or more beacon as described in U.S. Pat. No. 8,396,485 or U.S. Published Patent Application No. 2013/0343198, the entire disclosures of which are hereby incorporated in their entirety.

The sensors may be placed at various places throughout the target store and provide a signal or locating beacon over a small area around the sensor. In various exemplary embodiments, the signal or locating beacon is receivable by mobile computing devices, such as smartphones, tablets, PDAs, portable media players, and the like, or other portable electronic devices such as wearable technology, and broadcasts a unique identification number, sequence, code, information or the like.

In various exemplary embodiments, the unique identification number, sequence, code, information or the like may be associated with a location, such as the location of the sensor. In various exemplary embodiments, this correlation may be coded into a pass, program application or the like that identifies and interacts with the sensors. For example, in various ones of these exemplary embodiments, the pass, program, application or the like may include or otherwise access a look-up table that translates the unique identification number, sequence, code or the like into a known location or other associated data.

In various other exemplary embodiments, rather than sending a unique identification number, sequence, code, information or the like, each sensor sends specific information, including location information. In such exemplary embodiments, a mobile computing device that has a compatible pass, program, application or the like stored in a mobile wallet on the mobile computing device may receive the specific information from one or more of the sensors and determine the location of the user using the mobile computing device. In various ones of these exemplary embodiments, the sensor may send generic location information. In various ones of these exemplary embodiments, the sensors may send particularly programmed location information. For example, in various exemplary embodiments, the sensors may be placed throughout a target store and programmed with store specific location information (e.g., row or aisle numbers, product areas, or store locations such as “front entrance,” “southwest corner” or “check-out lanes”).

In various exemplary embodiments, the location information, whether sent by the sensors or retrieved by the mobile computing device in correlation with information received from the sensors, triggers an event associated with the pass, program, application or the like. Example events include: messages to the end user; messages sent from the mobile computing device to the sensors; and changing the content of the pass (e.g., text displayed to the end user in association with the pass, program application or the like).

In various exemplary embodiments, rather than being particularly identified with a location, the information sent from the sensors may be associated with an event. In practice, it may be intended that the event be activated at a designated location, however, the particular location may not be of importance. For example, if the event triggers a coupon for a particular item, the sensor may be moved throughout the target store depending on the orientation or layout of the store to ensure that the event occurs near the target item. In such exemplary embodiments, a sensor may not be programmed with actual location information, but may be programmed with effective location information, such as the products available near the sensor.

In an exemplary embodiment of the use of the described marketing systems, a marketer may program software that reacts to a pass, that creates content for the end users advertising a sale on one or more particular products offered in its retail stores. The pass may be downloaded, saved or generated on an end user's mobile computing device and stored in a mobile wallet. When the user approaches one of the marketer's retail stores, as determined for example by location information collected on the mobile computing device and accessible by the mobile wallet, the pass may generate or display a message or alert to the end user that reminds or informs the user that the particular products are on sale at the retail store. The message accessed by the pass will have been created using software that manages which marketing messages are displayed to users based on specific location information. Upon entering the store, information received from one or more sensors may alter the information presented by the pass or shown to the end user. For example, a sensor may send information associated with or correlating with one or more specific products on shelves or otherwise available near the sensor. When the mobile computing device receives information from such a sensor, it may display a message to the end user alerting the end user that it is near the one or more specific products.

In various other exemplary embodiments, the generic or specific location information retrieved from or associated with the one or more sensors may provide an opportunity to interact with the end user. For example, the mobile computing device may receive specific location information (either from one or more sensors themselves or retrieved from other information received from the one or more sensors) correlating to an aisle number within a store. If the user is interested in purchasing or viewing items in another aisle, the pass may be programmed to guide the end user to the desired items. For example, if the mobile computing device receives information indicating that the end user is at the North end of aisle 5 in a store, and the desired item is in aisle 7, which is, for example, 2 aisles West of aisle 5, the pass may inform the user to walk to the nearest end of the aisle, turn left and walk down two aisles to find the desired items.

Similarly, in various exemplary embodiments, a pass, such as a concert ticket, may provide detailed directions to various locations based on information received from the one or more sensors. For example, one or more sensors at the entrance used by the end user may provide information that identifies the particular entrance or gate used. A program, application or the like may then update to provide directions to the end user's assigned seat, bathrooms, concession areas, memorabilia stands or other desirable locations. In various exemplary embodiments, the program, application or the like may update again as the user passes additional sensors to refine or update the directions displayed to the user. Likewise, the program, application or the like may generate a venue map with an icon to indicate the location of the end user within the venue based on information received from one or more sensors and may additionally provide information received from the pass itself, such as an icon indicating the user's assigned seat.

In various other exemplary embodiments, software can be used to create content used by a pass to inform users that various items are on sale “while supplies last.” In such exemplary embodiments, the software determines content to display when a user with the pass is located at the front entrance of the store to inform the end user which items have sold out and which items are still available.

In various other exemplary embodiments, a pass, program, application or the like may be programmed to access external information related to information received from one or more sensors. For example, a pass, program, application or the like may be programmed to provide links to recipes that utilize ingredients associated with a sensor such that the user is provided with links relevant to the ingredients available by the users (e.g., an apple pie recipe when the user passes fresh apples, or a roast chicken recipe as the user passes the poultry section). In another example, a pass, program, application or the like may be programmed to provide links to project ideas or self-help guides that relate to products associated with a nearby sensor (e.g., a self-help video regarding how to lay floor tiles when the user passes floor tiles, or a how-to video related to a new product for sale near the sensor). In such exemplary embodiments, the pass, program, application or the like may actively update as the end user browses through the store and provide relevant links based on whatever products the end user is near at each particular moment.

It should be appreciated that other information relevant to various products may be displayed to the end user. Likewise, in various exemplary embodiments, the pass, program, application or the like may be programmed to send information from the portable electronic device to the sensors to, for example, track how many people have downloaded or accessed the pass, program, application or the like and then subsequently visited the corresponding retail store location; or track the shopping habits of end users (e.g., whether users frequently go from a first area of the store to the same second area of the store, whether users frequently make their first stop in one particular area, or how long users spend shopping in various locations throughout the store).

In various other exemplary embodiments, the pass, program, application or the like may retrieve information stored on a remote server that is updated from information received from one or more sensors and one or more mobile computing devices interacting with the sensors. For example, sensors placed near bathrooms or concession stands at a concert venue may send and receive information from end users with associated passes, programs, applications or the like, such as, for example, concert tickets. The sensors may additionally communicate with one or more remote servers to provide an approximation of the number of users near the bathrooms or concession stands such that the pass, program, application or the like shown to an end user not near the bathroom and communicating with the one or more remote servers can approximate the wait time at the bathrooms or concession stands.

In another embodiment, an application or program may be provided wherein a marketer or retailer enters information about one or more products and the information is received by a mobile computing device, such as a smartphone or the like, via conventional wireless data transmission means. When the user takes the mobile computing device into an associated retail store, location information is received by the smartphone that correlates to the information previously received by the mobile computing device. This, in turn, results in the mobile computing device entering an in-store mode wherein content information is provided to the user of the mobile computing device that matches the information entered by the marketer or retailer and records of items that the user may have searched for in the past or entered via an application loaded on the mobile computing device.

In another exemplary embodiments, a software development kit (“SDK”) is provided that facilitates integration of various features of mobile computing devices. For example, an SDK may be provided that facilitates integration of short message service (“SMS”) messages with push notifications, mobile wallets, passes, programs, applications or the like. In various ones of these exemplary embodiments, the SDK is used to provide desired communications to end users based, at least in part, on the end users' locations as determined by, for example, information provided by one or more of the sensors described above.

In various other exemplary embodiments, a marketing platform makes decisions based on information collected from, for example, an end user's location, the end user's preferences, information collected about the end user from external sources (such as, for example, social media sources), external data collected from external providers (such as, for example, weather information based on the user's location). The decisions made by the marketing platform relate to preferred information to display or provide to the end user such as, for example, marketing information related to particular items that may be desirable based on the information collected. In one such exemplary embodiment, weather information may be used, potentially in connection with other information, to determine desirable items or information to present to the end user such as, for example, notifying the end user that umbrellas are on sale and that the weather forecast calls for rain within the next five days.

1. A marketing and advertising system comprising:
one or more beacons placed in one or more predetermined desired locations, wherein the one or more beacons transmit desired information that can be received by one or more portable electronic devices carried by one or more end users; and
and one or more digital marketing devices operating on the one or more portable electronic devices;
wherein the desired information includes location determinative information that can be utilized by the one or more digital marketing devices.

2. The marketing and advertising system of claim 1, wherein the one or more beacons are Bluetooth LE beacons.

3. The marketing and advertising system of claim 1, wherein the one or more portable electronic devices comprise one or more smartphones.

4. The marketing and advertising system of claim 3, wherein the one or more digital marketing devices comprise one or more passes loaded on the one or more smartphones.

5. The marketing and advertising system of claim 1, wherein the location determinative information identifies one of the one or more predetermined desired location where the one or more beacons are placed.

6. The marketing and advertising system of claim 1, wherein the one or more digital marketing devices utilize the location determinative information to update an informative message displayed to the one or more end users.

7. The marketing and advertising system of claim 6, wherein the one or more digital marketing devices are capable of displaying particularized information to the one or more end users based on the location of the one or more end users as determined by the location determinative information.

8. The marketing and advertising system of claim 7, wherein the one or more digital marketing devices are capable of displaying sales information for one or more products being sold near one of the one or more predetermined desired locations.

9. The marketing and advertising system of claim 7, wherein the one or more digital marketing device is capable of displaying directions to the one or more end users.

10. The marketing and advertising system of claim 9, wherein the directions displayed to the one or more end users update as the one or more end users move in relation to the one or more beacons.

11. The marketing and advertising system of claim 1 further comprising a remote server.

12. The marketing and advertising system of claim 11, wherein the one or more digital marketing devices is capable of transmitting the location determinative information to the remote server.

13. The marketing and advertising system of claim 12, wherein the remote server sends information to a first group of end users based on the location determinative information received from the one or more digital marketing devices.

14. The marketing and advertising system of claim 13, wherein the one or more end users are a subset of the first group of end users.

15. The marketing and advertising system of claim 13, wherein the information sent to the first group of end users comprises historical data about the location of the one or more end users.

16. A method of providing marketing and advertising information to an end user comprising:
transmitting data from one or more beacons, the data containing location determinative information;
receiving the data with a portable electronic device;
processing the data, to determine a location;
displaying marketing and advertising information on the portable electronic device based on the location.

17. The method of claim 16, further comprising sending at least a subset of the data to a remote server.

18. The method of claim 17, wherein the data is processed by the remote server to determine the location.

19. The method of claim 17, further comprising retrieving the marketing and advertising information from the remote server.

20. The method of claim 16, wherein the data is processed on the portable electronic device.
